(19) United States
(12) Patent Application Publication
(10) Pub. No.: US 2004/0190380 A1
(43) Pub. Date: Sep. 30, 2004

(54) Personal electronic device having custom mode setting feature

(75) Inventor: Craig Wojcieszak, Lee, NH (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Fila Luxembourg S.A.R.L., Luxembourg (LU)

(21) Appl. No.: 10/693,891

(22) Filed: Oct. 28, 2003

Related U.S. Application Data
(60) Provisional application No. 60/456,548, filed on Mar. 24, 2003.
(60) Provisional application No. 60/456,549, filed on Mar. 24, 2003.

(51) Int. Cl. G04C 17/00; G04C 21/00; G04C 19/00

(52) U.S. Cl. 368/69

(57) ABSTRACT

An electronic device including a case, and electronics module and an input mechanism. The electronics module is contained by the case and includes at least a processor and a memory configured to store a plurality of available mode settings for the electronic device. The input mechanism is configured to provide input commands to the processor which is configured to, based on the input comments, configure the electronic device to provide a custom mode setting for a subset of the plurality of available modes.

### CROSS-REFERENCE TO RELATED APPLICATIONS

This application claims priority to U.S. Provisional Application Serial No. 60/456,548, filed on Mar. 24, 2003. This application is related to U.S. Provisional Application Serial No. 60/456,549, filed on Mar. 24, 2003; and U.S. utility application entitled “HOUSING FOR ELECTRONIC DEVICE WEARABLE ON USER'S FINGER” filed Oct. 28, 2003 (Attorney Docket No. 244707US 17). The contents of these applications are incorporated herein by reference.

### BACKGROUND OF THE INVENTION

1. Field of the Invention

The present invention relates generally to personal electronic devices, and more particularly to personal electronic devices having multiple modes of operation that can be selected by the user to provide a custom group of operating modes.

2. Discussion of the Background

Typical consumer electronic devices, such as watches, mp3 players, heart rate monitors, pedometers, GPS, etc. have various modes (A, B, C, D, E, F . . . ), each mode performing a distinct function at the user's request. Buttons, dials or similar devices are used to sequentially change from one mode to the next. For example, such a device, operating in mode A can only be changed to mode F, via mode B, then C, then D, then E, and finally to mode F. However, these conventional devices do not provide a mechanism to change from mode A directly to mode C for instance. The present inventors have discovered that this causes a problem in that the user of a conventional device may be required to focus on the electronic device for too long a period of time. Such “target fixation” my cause a hazardous situation where the user of the device is doing an activity that requires full attention, such as running outdoors.

In addition to the safety hazards associated with target fixation, present inventors have discovered that the conventional devices noted above are very inconvenient because the user must scroll through unnecessary or unused functions to gain access to the user's desired function. Currently, to avoid this inconvenience, the user would need to have an electronic device custom made to include the exact combination of desirable functions from the user. Such a custom device would be very expensive and is therefore not feasible. Moreover, even if such a custom device were feasible, the user's desired features may change over time making the custom device less useful to the user. Finally, because different users of electronic devices desire different features for the device, manufacturers must make a single device having very many features, which leads to the inconvenience described above. Alternatively, manufacturers can make different watches having different features in order to target a wide consumer base; however, this leads to added manufacturing expense.

### SUMMARY OF THE INVENTION

The present invention is directed to reducing or eliminating the above-described problems and/or other problems in the art.

In addition, the present invention is directed to providing custom mode settings for a personal electronic device.

These and other features of the present invention may be provided an electronic device including a case, and electronics module and an input mechanism. The electronics module is contained by the case and includes at least a processor and a memory configured to store a plurality of available mode settings for the electronic device. The input mechanism is configured to provide input commands to the processor which is configured to, based on the input comments, configure the electronic device to provide a custom mode setting for a subset of the plurality of available modes.

In another aspect of the invention, a method of setting custom modes in an electronic device includes operating an input mechanism of the electronic device to initiate a custom mode setting sequence, operating the input mechanism to select one of a plurality of available modes of operation of the electronic device, and operating the input mechanism to toggle the selected mode on or off. A mode toggled off is unavailable for use by a user of the electronic device.

In another aspect of the invention a computer-readable medium contains program instructions for execution on a processor, which when executed by the processor, cause the electronic device to initiate a custom mode setting sequence, select one of a plurality of available modes of operation of the electronic device in response to user input, and toggle the selected mode on or off in response to user input. A mode toggled off is unavailable for use by a user of the electronic device.

Yet another aspect of the invention includes an electronic device having means for containing an electronic module, including at least a processor, means for storing a plurality of mode settings, and means for inputting input commands to the processor. The processor is configured to, based on the input commands, configure the electronic device to provide a custom mode setting for a subset of the plurality of available modes.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1a and 1b show an exemplary packaging of a watch for implementing the custom mode feature according to an embodiment of the present invention;

FIG. 2 is an electronic block diagram showing the architecture of an electronic device in accordance with one embodiment of the present invention;

FIG. 3 is a flow chart showing a general operation of an electronic device having the custom mode setting feature in accordance with an embodiment of the present invention;

FIG. 4 is a flow chart showing a conventional mode operation process for a digital watch in comparison to a process for setting custom modes in accordance with an embodiment of the present invention;

FIG. 5 is a process flow diagram showing the custom mode setting feature of the present invention according to another embodiment of the present invention; and

FIG. 6 is an exemplary display that may be used in an electronic device in accordance with the present invention.

### DESCRIPTION OF THE PREFERRED EMBODIMENTS

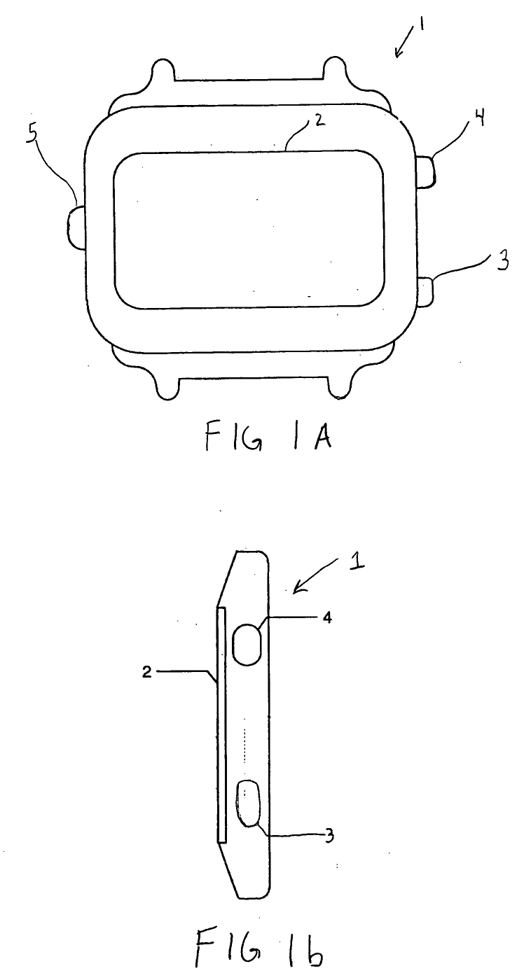

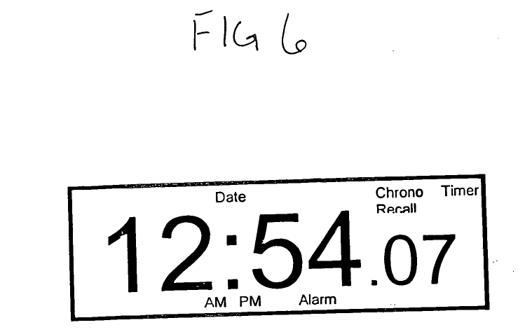

Referring now to the drawings, FIGS. 1a and 1b show an exemplary packaging of a watch for implementing the custom mode feature according to an embodiment of the present invention. The watch case 1 contains a display 2, and three selector buttons 3, 4, and 5. The display 2 is used to display the operational features of the watch 1 as will be described further with respect to exemplary FIG. 6 below. The mode buttons 3, 4 and 5 are buttons that can be depressed by the user of the watch 1 in order to operate the various features available on the watch. It is to be understood that the custom mode setting feature of the present invention is not limited to watches and can be implemented on any personal electronic device. The custom mode setting feature of the present invention is particularly useful for personal electronic devices having a relatively small display and a limited number of input buttons such as in the example shown in FIGS. 1a and 1b. However, it is to be further understood that the packaging of the watch in FIGS. 1a and 1b is exemplary only, and one of ordinary skill in the art would be able to provide different packaging to implement the custom mode setting feature of the present invention.

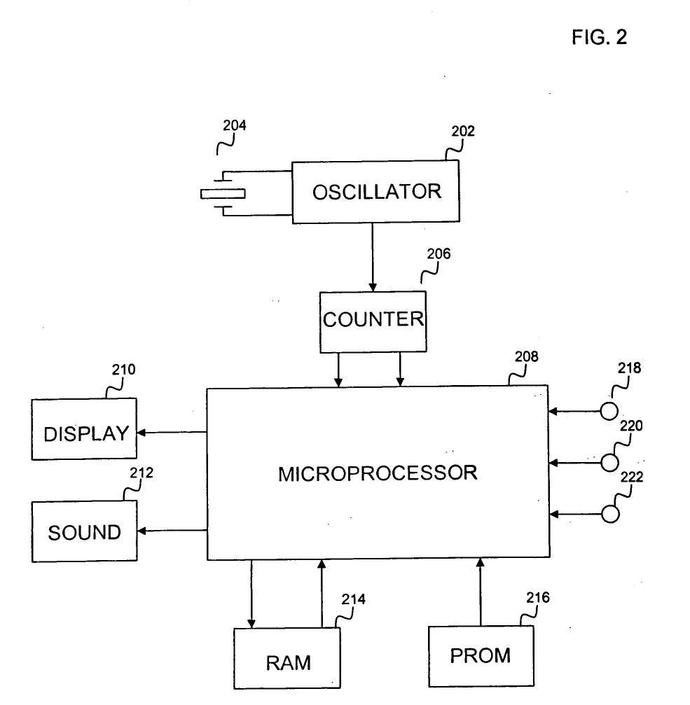

FIG. 2 is an electronic block diagram showing the architecture of an electronic device in accordance with one embodiment of the present invention. As seen in this figure, the electronic device includes an oscillator 202, a crystal 204 and a counter 206 that provides inputs to a microprocessor 208. The microprocessor 208 is also coupled to a display 210, a sound device 212, a random access memory (RAM) 214 a programmable random access memory (PROM) 216 and input switches 218, 220, and 222. The time base oscillator 202 and associated crystal 204 produces a sequence of pulses driving the counter 206 to provide an output frequency to the microprocessor 208. The counter 206 is preferably a frequency dividing counter that provides at least two output bit streams that are read into the microprocessor 206, which uses the inputs from the counter to update software counters kept in random access memory 214 (RAM) that control all timing functions, for example. The software program controlling the microprocessor 208 is contained in a programmable read only memory 216 (PROM). A display 210 contains a memory, address logic, display drivers, and optoelectronics for display of the characters and other symbols, preferably in the form of binary pixels. The device also contains a sound circuit 212 having an auditory amplifier, speaker and any other control logic and circuitry appropriate for providing audio, such as a beeping alarm. Selector buttons 218, 220, and 222, when pressed by the user, transmit a signal to the microprocessor.

While not shown in FIG. 2, the electronic device may include a battery as a power source. In one embodiment, the watch uses a CR1025 3V button cell, which in normal circumstances will be good for years. However, the battery life will vary due to shelf time and the frequency the EL backlight (described below), alarm and hourly chime are used.

It is to be understood that the system in FIG. 2 is for exemplary purposes only, as many variations of the specific hardware and software used to implement the present invention will be readily apparent to one having ordinary skill in the art. For example, the functionality of the counter 202 and oscillator 206 may be combined in a single device. Examples of digital watches are disclosed in U.S. Pat. Nos. 5,477,508, 4,320,478, and 4,120,148, each of which is incorporated herein by reference.

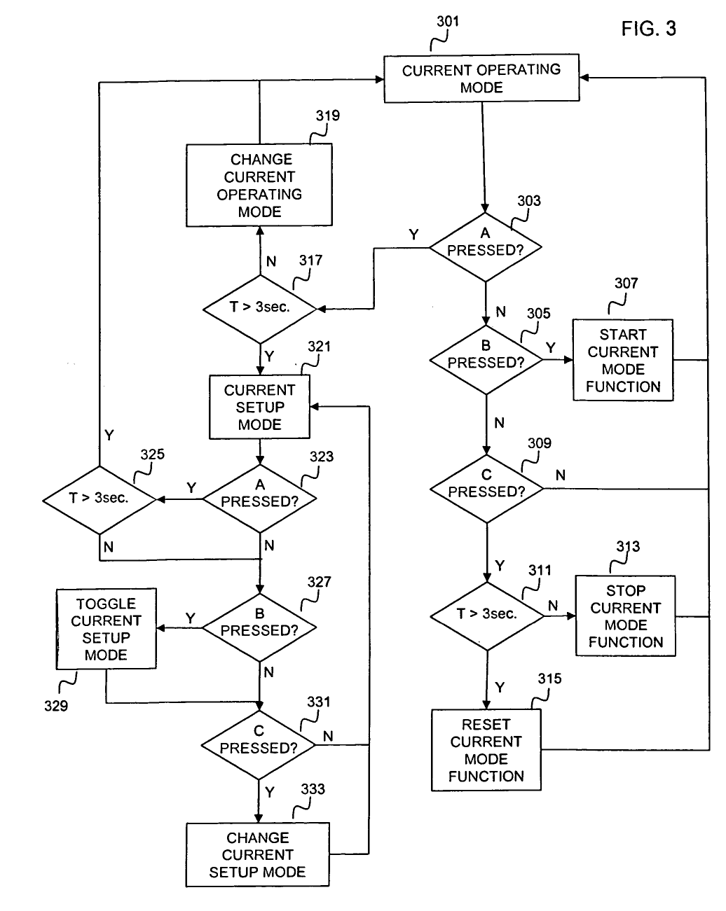

FIG. 3 is a flow chart showing a general operation of an electronic device having the custom mode setting feature in accordance with an embodiment of the present invention. The process shown in FIG. 3 is implemented on an electronic device having three input buttons such as that shown in FIGS. 1 and 2. The input buttons are generically referred to as “A,” “B,” and “C” in the flowchart. As seen in FIG. 3, the electronic device is in a current operating mode as shown by step 301. The current operating mode is the currently selected one of the plurality of operating modes provided by the electronic device. In the embodiment shown, sequential monitoring of whether one of the mode buttons is depressed is accomplished by decision block 303, which monitors the A button, decision block 305, which monitors the B button, and decision block 307, which monitors the C button. Where the A button is pressed, a process flow for changing and/or setting up an operating mode is initiated, as seen in decision block 303. The process flow relating to pressing button A in decision block 303 will be described below. Where button B is depressed, the process continues to step 307, where the electronic device starts a current mode operation. Where the electronic device is a watch, the current mode operation may be a “stopwatch” function, which is started in step 307. That is, pressing button B when the device is in stopwatch mode will start the timer of the stopwatch. Once the current mode function is started in step 307, the process returns to step 301 where monitoring of the input buttons in the normal operation sequence resumes.

In decision block 309, if button C is not depressed, the process returns to step 1, where monitoring of the input buttons resumes. Where button C is depressed, the process continues with decision block 311. In step 311, a determination is made whether the C button is depressed and quickly released, or depressed and held for more than three seconds. Where button C is not held for more than three seconds, the process flows to step 313 where the current mode function, such as the stopwatch started with button B as described above, is stopped. Once the current mode function is stopped in step 313, the process returns to step 301 where monitoring of the input buttons resumes. Where button C is depressed for more than three seconds, the current mode function is reset as shown in step 315. Continuing with the timer example introduced above, step 315 may include resetting the timer to zero seconds. Once the current mode function is reset in step 315, the process returns to step 301 where monitoring of the input buttons resumes.

Turning again to decision block 303, where button A is depressed by the user, the process continues with the electronic device determining whether the button A is depressed and quickly released, or depressed and held for more than three seconds. Where button A is not held for more than three seconds, the process flows to step 319 where the current operating mode is changed to another one of the multiple operating modes offered by the electronic device. For example, if the user wishes to change from a stopwatch function to an alarm function, the user would depress and quickly release button A. Changing of the current operating mode may take place in sequence or by display of a menu on the monitor of the device. Moreover, because the operating modes are fixed in number, in a preferred embodiment the process is configured to cycle through all operating modes and then restart at the first operating mode. That is, by pressing the A button in rapid succession, the user can scroll through the available operating modes until the desired mode is found. Once the current operating mode is changed in step 319, the process returns to step 301 where monitoring of the input buttons resumes.

Where button A is depressed and held for more than three seconds in step 317, the process continues to step 321, where a current setup mode is displayed so that the multiple modes of the electronic device can be customized. For example, where the electronic device includes five modes of operation and the user only wishes to use three desired modes, the user presses and holds button A to enter a custom mode setting sequence where the user can operate buttons B and C to select custom modes.

As seen in FIG. 3, once the user enters the custom mode sequence in step 323, buttons A, B, and C are monitored in the custom mode sequence to determine if they have been depressed as shown by decision blocks 323, 327, and 331. Where button A is depressed, the process continues with decision block 325, where determination is made whether button A was released or held for more than three seconds. Where button A was held by the user for more than three seconds, the process exits the custom mode setup sequence and returns to the current operating mode in step 301, where the buttons are again monitored in the regular operation mode sequence of steps 303-315. If in the custom mode sequence begun in step 321, the A button is not pressed or inadvertently pressed and quickly released, the process remains in the custom mode setting sequence, and monitoring of the input buttons in this sequence continues. Where button B is determined to be pressed in decision block 327, the current setup mode is toggled on or off as shown in step 329. Thus, if the user wishes to disable the current setup mode and exclude this mode from the normal operating modes of the electronic device, then the user toggles the current setup mode to off by depressing button B of the electronic device.

In decision block 331, determination is made whether button C is pressed by the user. If button C is not pressed, then the process returns to step 321, where the buttons are monitored in the custom mode setup sequence. Where button C is pressed, the process continues with step 333, where the current setup mode is changed to another of the available modes provided by the electronic device. Changing of the available modes may take place in sequence or by display of a menu on the monitor of the device. Moreover, because the available modes are fixed in number, in a preferred embodiment the process is configured to cycle through all available modes and then restart at the first available mode setting. That is, by repeatedly pressing button C in the current setup mode sequence, the user can scroll through the available modes until a particular mode is found.

A preferred embodiment of the invention would work in conjunction with multifunction watches, such as in a 3-button watching having:

Button A: Mode/Customize Subset: user presses once to change mode, and presses and holds for 3 seconds to customize subset.

Button B: user presses to start a function while in a mode, and presses to toggle a mode ON/OFF while customizing the subset.

Button C: user presses to stop a function while in a mode, and presses and holds for 3 seconds to reset a function while in a mode. User also presses to cycle to the next mode for Activation/Deactivation while customizing the subset.

With this configuration, if the watch has 6 modes I, II, III, IV, V and VI, the custom mode feature may be accomplished as follows:

1. Initially each press of Button A will cycle one step through the list of 6 modes above, changing the device function accordingly.

2. Then the user enters Customize Subset by pressing and holding Button A.

3. The user cycles through mode I, leaving it toggled to ON.

4. The user cycles to each of the modes II, III, & IV, toggling them to OFF.

5. The user cycles to mode V & leaves it toggled to ON.

6. The user cycles to mode VI and toggles it to OFF.

7. The Customized subset now consists only of modes I and V.

8. Pressing Button A will now cycle only between modes I & V until the subset is customized again.

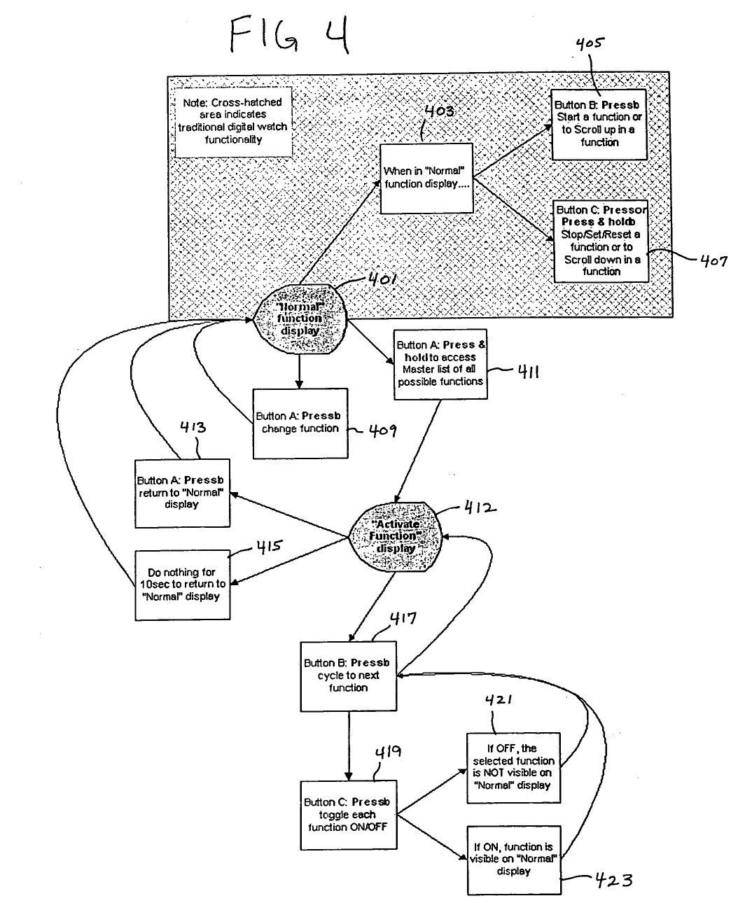

FIG. 4 is a flow chart showing a conventional mode operation process for a digital watch in comparison to a process for setting custom modes in accordance with an embodiment of the present invention. As seen in this figure, the cross hatched area of the flow chart indicates the portion of the flow chart generally provided by conventional digital watches. In the area, the watch provides a “normal” function display as shown by display function 401. When in this display (step 403) pressing button B allows the user to start or scroll up in a function in step 405, and button C allows stop/set/reset or scroll down in a function as shown in step 407. When button A is pressed in the normal function display, the function is changed as shown by step 409.

In the embodiment shown in FIG. 4, the inventive process displays a master list of all possible functions in the custom mode setting sequence when button A is pressed and held for a period of time as shown by 411. This is the “active function” display shown by 412. The user can manually exit the active function display by pressing button A as seen in step 413. In addition, in step 415 the process automatically exits a custom mode setting sequence and active function display when the user does not provide input for ten seconds. Where button B is pressed in step 417, the active function display cycles to the next function. With each function displayed, the user can toggle the function on or off as shown by step 419. If the function is toggled “off,” the function will not be visible in the normal display mode as shown by step 421. However, if toggled “on,” the function will be visible in normal display mode as seen in step 423. That is, in the embodiment of FIG. 4, each of the modes or functions that are toggled off will be removed from the display of the digital watch.

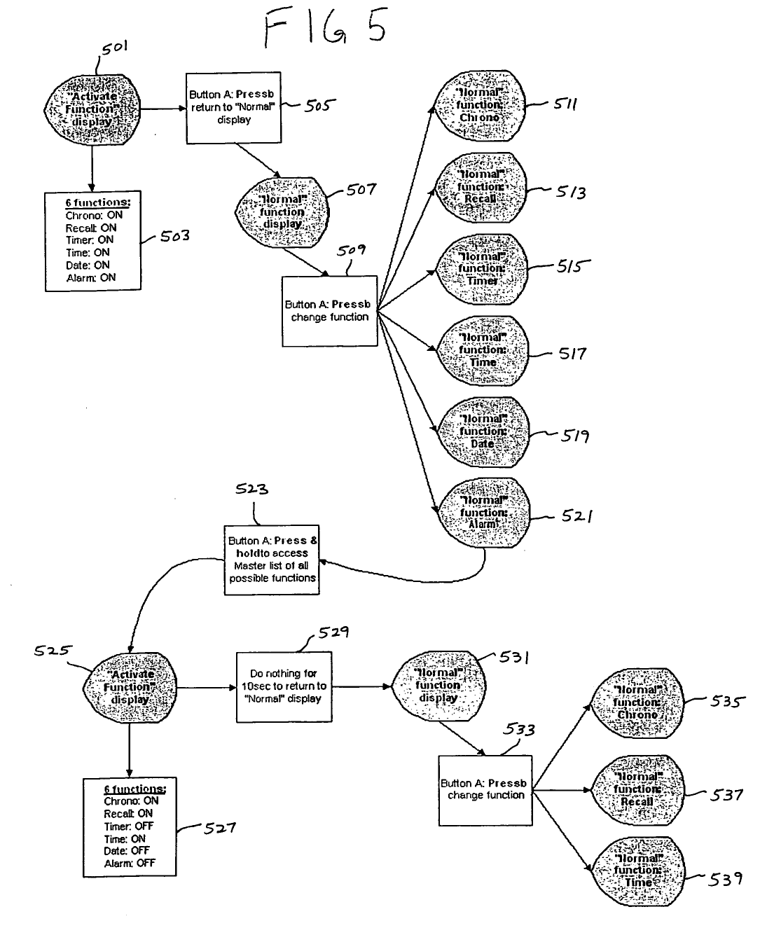

FIG. 5 is a process flow diagram showing the custom mode setting feature of the present invention according to another embodiment of the present invention. As seen in FIG. 5, the embodiment of that figure utilizes three input buttons for providing custom mode setting of Chronograph, 50-lap Recall, Countdown Timer (including a repeat function), Time, Date, Alarm, and EL backlight features. Initially in the activate function display 501, all six functions (chrono, recall, timer, time, date and alarm) are toggled in the “on,” position as shown by step 503. Therefore, when button A is pressed to return to the normal display as in step 505, the normal function display 507 enables the user to cycle through all six functions by pressing button A as shown by step 509. That is, repeatedly pressing button A in step 509, causes the normal function display to display chrono 511, recall 513, timer 515, time 517, date 519, and alarm 521. When the user wishes to customize the mode features, button A is pressed and held to access a master list of all possible functions, as shown in 523. In the activate function display 525, in an embodiment of FIG. 5, the user operates the mode buttons to toggle off the timer, date, and alarm modes as shown in step 527. Then, the user does nothing for 10 seconds as shown in step 529 and the display returns to the normal display 531. Then, by pressing button A to change the functions in step 533, the user can only cycle through the normal function chrono 535, normal function recall 537, and normal function time 539, which were toggled to the “on” position in the activate function display.

A more specific example of the present invention will now be described. A digital watch implementing the present invention may be implemented as the configuration of FIGS. 1-2 and may include the following modes:

1/100 sec Chronograph

50-lap Recall

Countdown Timer (including a repeat function)

Time

Alarm

Date

EL backlight

In addition, the watch may have the following 3 control buttons:

MODE

START/LAP

STOP/RESET

With the configuration of this specific embodiment, the user can choose the normal operating modes as follows:

1. Press & hold the MODE button for 2 seconds (in any display mode). The display will show CUS.

2. Press the START/LAP button to cycle through all the available normal modes; EL, Alarm, Date, Time, Timer, Recall, Chrono, and Beep. These modes are all defaulted to be ON.

3. Press the STOP/RESET button to toggle any of these normal modes ON or OFF

4. Press the MODE button (or press nothing for 10 seconds) to return to normal operation mode display.

5. When the watch returns to normal mode display, only the modes toggled to ON will be available by pressing the MODE button.

However, if no functions are toggled ON, the watch display may “freeze” requiring the user to follow the directions HOW TO RESET THE WATCH, described below, to correct this problem.

Thus, in this specific embodiment, the watch can display any of the six normal operation modes; CHR (chronograph), REC (recall), TMR (timer), TIME, DATE, and ALM (alarm). As seen in FIG. 6, the display includes a large time display portion as well as smaller mode indicator displays. In a preferred embodiment, only those modes that are selected for operation using the custom mode setup feature are displayed on the display of the watch. To change the display from one mode to the next, the user presses the MODE button once. The mode description will appear briefly before the mode is activated.

The following is a description of how to use the different modes of operation according to an embodiment of the present invention. Any or all of the modes described below can be implemented with any of the embodiments of the electronic device described herein. Moreover, the described modes may be combined with other modes not specifically described herein:

How to Use the Chronograph

To time a single event the user performs the following steps:

1. Select the CHRONO mode by pressing the MODE button.

2. Press the START/LAP button to start.

3. Press the STOP/RESET button to stop.

4. Press & hold the STOP/RESET button for two seconds to reset the chronograph.

To use the lap feature the user performs the following steps:

1. Select the CHRONO mode by pressing the MODE button.

2. Press the START/LAP button to start.

3. Press the START/LAP button again to start each new lap (and end the current lap).

The last lap time and the last lap number will be displayed alternatively every 3 seconds for a period of 12 seconds.

After 12 seconds, the display will alternate every 3 seconds, showing the cumulative time & the current lap time. A small “LAP” icon above the last two digits indicates the current lap time. No “LAP” icon indicates the cumulative time.

4. Press the STOP/RESET button to stop.

5. Press & hold the STOP/RESET button for two seconds to reset the chronograph.

The chronograph counts from 0 hour, 0 minute and 00.00 second to 23 hours, 59 minutes and 59.99 seconds. When the maximum is reached, the time will be entered as a lap automatically.

How to Use the Recall Mode

1. Select the RECALL mode by pressing the MODE button.

2. The display will alternate showing the following:

On the 1^{st} lap, the lap number & lap time.

On additional laps, the lap number, lap time and cumulative time. A small “LAP” icon above the last two digits indicates the current lap time. No “LAP” icon indicates the cumulative time. The cumulative time equals the total time after the final lap.

3. Press the START/LAP button to scroll to the next lap.

4. Press the STOP/RESET button to scroll to the previous lap.

In addition, Recall Mode will display two short dashed lines & the Recall icon if there are no laps in memory.

How to Use the Timer

To set the countdown time the user performs the following steps:

1. Select the TMR mode by pressing the MODE button.

2. If the timer is running, press STOP/RESET to stop.

3. Press and hold the STOP/RESET button. The hour digits will blink.

4. Additional presses of the STOP/RESET button will make the minutes or seconds digits blink, or REP blink. REP allows you to choose whether the timer repeats the countdown or stops after reaching zero.

5. Press the START/LAP button to set the blinking digits or to toggle the Repeat timer feature ON or OFF.

6. Press the MODE button to confirm.

To start a countdown while in Timer mode the user performs the following steps:

1. Press the START/LAP button.

2. Warning beeps will be emitted 3 seconds prior to reaching zero.

3. The beeps change pitch when the countdown reaches zero.

4. Press any button to mute the beeping.

5. The timer will be reset to the countdown time after 0.5 seconds.

6. Depending on your choice for the REPEAT option, the timer will stop or begin counting again.

In addition, the user can set the timer from 0 hour, 00 minute and 00 second to 23 hours, 59 minutes and 59 seconds.

How to Set the Time

1. Select the TIME mode by pressing the MODE button.

2. Hold down the STOP/RESET button for two seconds. The hour digits will blink.

3. Additional presses of the STOP/RESET button will make the minutes or seconds digits blink, make all the digits blink (for setting AM or PM), or 12/24-H blink

4. Use the START/LAP button to set the currently blinking item.

Pressing the START/LAP button when the seconds digits are blinking will reset the digits to 00. This will increase the time by one minute if the original setting is at 30 seconds or more.

Press the START/LAP button once to increase one unit or hold the button to speed up the process.

A small “PM” icon will indicate times between noon and midnight. No “PM” icon indicates morning times.

5. Press the MODE button to confirm and return to normal display.

6. The user can retain the set values and exit the setting procedure at any time by pressing the MODE button or by not pressing any button for 10 seconds.

How to Set and Use the Alarm

To set the Alarm the user performs the following steps:

1. Select the ALARM mode by pressing the MODE button.

2. Hold down the STOP/RESET button for two seconds. The hour digits will blink. Press again to make the minutes digits blink. Pressing one more times will make all the digits blink (for setting AM or PM). A small “PM” icon will indicate times between noon and midnight. No “PM” icon indicates morning times.

3. Use the START/LAP button to adjust the blinking digits.

4. Press the MODE button to confirm and exit.

To use the Alarm the user performs the following steps:

1. To activate the Alarm, press the START/LAP button while the daily alarm is displayed. The ALARM ON indicator will light up. Press the button a second time to deactivate the alarm.

2. To stop the alarm alert, press any button. In one embodiment, the Alarm is intended as an audible reminder for runners. It may not be loud enough to wake the user in the morning.

How to Set the Date

1. Select the DATE mode by pressing the MODE button.

2. Hold down the STOP/RESET button for two seconds. The month digits will blink.

3. Additional presses of the STOP/RESET button will make the date or year digits blink.

4. Use the START/LAP button to set the blinking digits.

5. Press the MODE button to confirm and exit. The entered date will be checked automatically for validity. Should it be invalid, the next valid date will be adopted.

In one embodiment, the user may enter any year from 2000 to 2049.

How to Use the EL Backlight

If EL mode is toggled ON in the Custom Mode (for example, for night use), the EL backlight will be switched on for 5 seconds when any button is pressed. If EL mode is toggled OFF in the Custom Mode (day use), the EL backlight will only be switched on for 5 seconds when pressing & holding the Mode button to enter the Custom Mode.

How to Reset the Watch

For a situation where the display “freezes”, as noted above, the user can reset the watch. To reset the watch, the user holds down the MODE, START/LAP and STOP/RESET buttons simultaneously for two seconds. The LCD will light up briefly and factory settings will be adopted. This procedure is useful when you want to erase all current settings. After resetting the watch, the user will need to reset the time, date, etc.

Thus, the present inventors have discovered an advantageous mechanism to control personal electronic devices having more than one mode of operation. The invention allows the user to activate or deactivate a subset of the device's modes of operation. The invention allows the user to create a subset of modes that the “mode” button controls. The “mode” button then sequentially changes from one mode to the next within this subset. For example, the user can create a subset consisting only of modes A, D, & F. The “mode” button will then simply sequentially change from A to D to F to A, etc until such time as the user changes the subset of active modes.

Obviously, numerous modifications and variations of the present invention are possible in light of the above teachings. It is therefore to be understood that within the scope of the appended claims, the invention may be practiced otherwise than as specifically described herein.

1. An electronic device comprising:
a case;
an electronics module contained by said case and including at least a processor and a memory configured to store a plurality of available mode settings for the electronic device; and
an input mechanism configured to provide input commands to said processor, wherein said processor is configured to, based on said input comments, configure said electronic device to provide a custom mode setting for a subset of the plurality of available modes.

2. The electronic device of claim 1, wherein said case comprises a digital watch case.

3. The electronic device of claim 1, wherein said case comprises a personal electronic device case having a relatively small display and three or fewer selection buttons as said input mechanism.

4. The electronic device of claim 1, wherein said electronics module further comprises a crystal oscillator that provides digital timing inputs to the processor.

5. The electronic device of claim 1, wherein the input mechanism comprises at least one selector button.

6. The electronic device of claim 5, wherein said at least one selector button comprises three selector buttons.

7. The electronics device of claim 6, wherein said three selector buttons comprise a mode button, a start/lap button, and a stop/reset button.

8. The electronic device of claim 1, wherein said processor operates in a current operation mode sequence where the input mechanism is used to initiate functions of a current mode of the electronic device.

9. The electronic device of claim 1, wherein said processor operates in a custom mode sequence where the input mechanism is used to select said subset of the available modes to be provided in a custom mode setting.

10. The electronic device of claim 1, wherein said available modes comprise at least one of a chronograph, a recall, a timer, a time, an alarm, a date, and an EL backlight mode.

11. The electronic device of claim 12, wherein said EL backlight mode provides backlighting for a display of said electronic device when the input mechanism is operated by the user.

12. The electronic device of claim 1, wherein said input mechanism is configured to provide a reset of the electronic device to clear at least one setting of the electronic device.

13. A method of setting custom modes in an electronic device, comprising:
operating an input mechanism of the electronic device to initiate a custom mode setting sequence;
operating the input mechanism to select one of a plurality of available modes of operation of the electronic device; and
operating the input mechanism to toggle said selected mode on or off, wherein a mode toggled off is unavailable for use by a user of the electronic device.

14. The method of claim 13, wherein said available modes comprise at least one of a chronograph mode, recall mode, countdown timer mode, time mode, alarm mode, date mode, and EL backlight mode.

15. The method of claim 13, further comprising operating the input mechanism to enter a normal operation sequence of the electronic device, wherein the input device is repeatedly operated to sequentially display the toggled on modes on a display of the electronic device.

16. The method of claim 15, further comprising selecting a mode of operation from said subset of modes.

17. The method of claim 13, further comprising operating the input mechanism to perform a reset of the electronic device.

18. A computer-readable medium containing program instructions for execution on a processor, which when executed by the processor, cause the electronic device to perform the steps in the method recited in any one of claims 13-17.

19. An electronic device comprising:
means for containing an electronic module, including at least a processor;
means for storing a plurality of mode settings;
means for inputting input commands to said processor, wherein said processor is configured to, based on said input commands, configure the electronic device to provide a custom mode setting for a subset of the plurality of available modes.
